(19) United States
(12) Patent Application Publication
(10) Pub. No.: US 2012/0226508 A1
(43) Pub. Date: Sep. 6, 2012

(54) SYSTEM AND METHOD FOR HEALTHCARE SERVICE DATA ANALYSIS

(75) Inventors: Crispian Lee Sievenpiper, Waukesha, WI (US); Yuan-Chyuan Sheu, Pewaukee, WI (US); Dariusz Ceglarek, Coventry (GB); Nagesh Shukla, Coventry (GB); Sudi Lahiri, Coventry (GB)

(73) Assignees: The Univesity of Warwick, Coventry (GB); General Electric Company, Schenectady, NY (US)

(21) Appl. No.: 13/041,149

(22) Filed: Mar. 4, 2011

(51) Int. Cl. G06Q 50/00; G06Q 10/00

(52) U.S. Cl. 705/3; 705/2

(57) ABSTRACT

Certain embodiments of the present disclosure describe the combined analysis of dynamic models and static models generated as part of a healthcare delivery process. Based on the combined analysis, As-Is and variation models (each having dynamic and static components) are generated. In one embodiment, the As-Is model components may be used in strategic planning. Likewise, in one embodiment, the variation model components may be used to derive respective dynamic and static quality metrics that may be used in report and control processes applied to the healthcare delivery process.

### BACKGROUND OF THE INVENTION

The subject matter disclosed herein relates to analyzing data related to the delivery of healthcare services, and in particular, to the automated or semi-automated analysis of both static and dynamic data related to healthcare service delivery.

Today's hospitals rely on a variety of healthcare information systems (HIS) that facilitate and/or coordinate the various functions of hospital operation. The use of such information systems throughout the entire hospital enterprise is typical in today's hospital operation. For example, such healthcare delivery systems may help manage, generate, or store certain types of static data, such as patient demographic data and/or electronic medical records. In addition, data may be generated about the healthcare delivery process itself, such as data related logging patient activities or movement, treatment timelines, monitoring records, and so forth.

As hospitals focus more on productivity and cutting cost to deal with high volume and tightened reimbursements, it has become important for hospital administrators to know where the deficiencies are across the entire hospital and the causes of these operation deficiencies. However, the mixture of data related to a patient's stay at a hospital is typically not useful for evaluating the operational efficiency of individual units within the hospital or of the hospital at large. In particular, no practical, structured approach exists for effectively extracting a model from the data to support analysis and improvement of hospital inefficiencies

### BRIEF DESCRIPTION OF THE INVENTION

In one embodiment, an iteative method for analyzing healthcare delivery data is provided. The method includes the act of generating a dynamic model describing a healthcare delivery process and a static model describing a patient pool. Both the dynamic model and the static model are jointly analyzed to determine one or more interactions between one or more subgroups of the patient pool and the healthcare delivery process. The healthcare delivery process is modified or monitored based on the one or more interactions to address the one or more interactions determined to exist for the one or more subgroups.

In one embodiment, a method for analyzing healthcare delivery data is provided. The method includes the act of providing a dynamic model and a static model as an input. The dynamic model is analyzed to identify constraints or sources of error in a healthcare delivery process. The static model is analyzed to identify one or more patient subgroups that fail to conform to a statistical expectation. An estimated As-Is model and an estimated variation model are derived based on the analysis of the dynamic model and the analysis of the static model. The As-Is model and the variation model are evaluated for interactions between the one or more patient subgroups and the healthcare delivery process. The As-Is model and the variation model are updated if interactions are identified.

In a further embodiment, one or more non-transitory computer-readable media are provided. The computer-readable media comprise one or more routines which, when executed by a processor, perform acts comprising: analyzing a dynamic model and a static model to generate an As-Is model and a variation model each having dynamic and static components and modifying or monitoring a healthcare delivery process based on the dynamic and static components of one or both of the As-Is model and the variation model.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a flowchart describing various steps, such as may be implemented as part of a computer executable algorithm, for processing dynamic and static data generated as part of a healthcare delivery operation, in accordance with aspect of the present disclosure; and

FIG. 2 depicts a flowchart describing various steps, such as of an algorithm, for analyzing the dynamic and static data of FIG. 1.

### DETAILED DESCRIPTION OF THE INVENTION

Healthcare delivery often involves the application and interplay of multiple, complex processes and operational constraints. Patient demand for, and response to, treatment can vary widely over time. As a result, patients with the same diagnosis may receive different care and/or may obtain different outcomes.

Various approaches directed to improving healthcare delivery analyze static behavior (i.e., data mining) or dynamic behavior (i.e., process mining). As used herein, data mining can be defined as exploring data sets to identify previously unknown patterns and trends. For example, data mining can involve the statistical analysis of large, static datasets, such as patient demographic data, electronic medical records, and so forth. A variety of healthcare quality metrics, key process indicators (KPI), and evidence-based medicine may utilize such data mining approaches.

Process mining uses activity logs to evaluate, monitor for conformance, and improve executing processes. In certain implementations, process mining combines service delivery models (e.g., process plans, chart, flow diagrams, and so forth) with tracking or deployment data (e.g., time-stamp data or logs recording milestones or implementation in performance of the delivery model) to understand the constraints of, conformance to, and extensions for the existing process.

The present disclosure relates generally to the analysis of static data (e.g., data mining) and dynamic data (e.g., process mining) generated as part of a healthcare delivery process. In particular, static models (i.e., time invariant models) and dynamic models (i.e., time varying models) may be generated and analyzed in conjunction with one another and the results of the analysis used in strategic planning and/or to update or generate quality metrics that may be used in assessing the ongoing healthcare processes. In certain embodiments, the combined analysis of static and dynamic data and/or models may be used to help address or reduce variations in outcomes that are observed in healthcare delivery.

The analyses described herein may be automated, such as implementing all or part of the processes using one or more suitably programmed algorithms or programs that are executed on one or more processor based systems (i.e., computers, workstations, servers, and so forth). Such automated implementations may acquire some or all of the data inputs discussed herein by automatically accessing data bases or datastores containing patient and/or hospital data, may process the data inputs to automatically generate models, reports and/or recommendations as discussed herein, and/or may automatically implement recommendations (schedule changes and so forth) generated based on the models or reports. As such, the approaches discussed herein may generally be understood to be transformative to the extent that raw, unprocessed data may be manipulated or processed to a new and useful form (i.e., models, reports, recommendations, and so forth) that is useful in a real-world medical setting to address or correct existing inefficiencies.

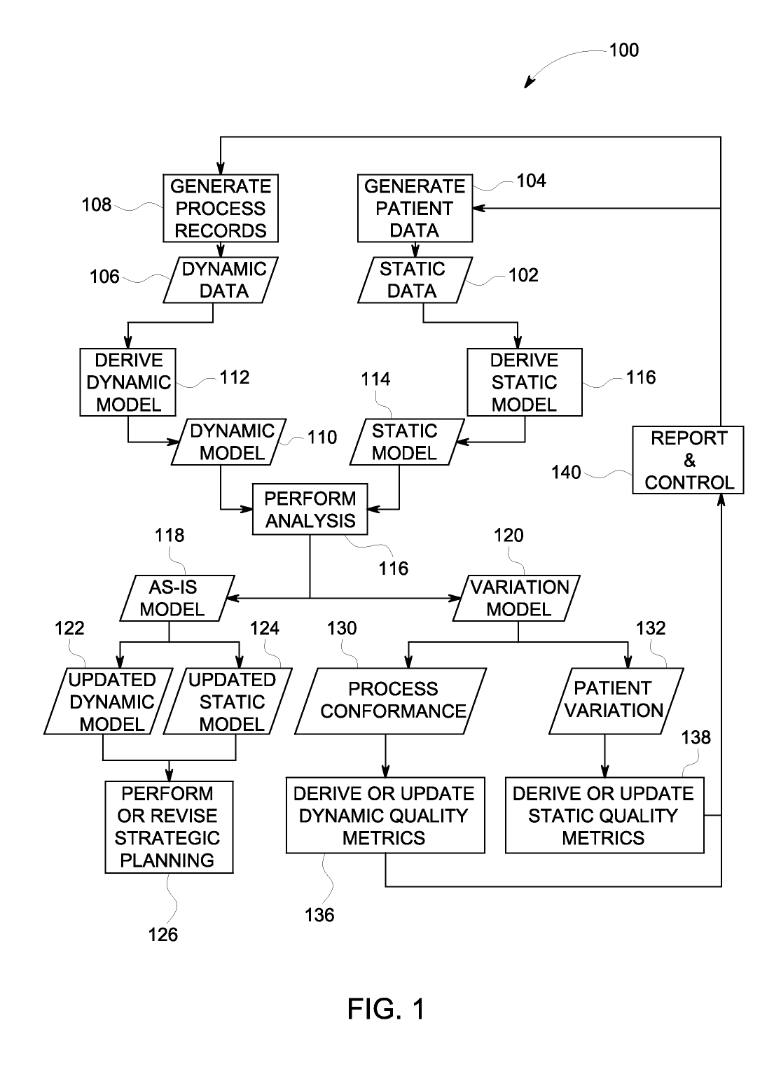

With this in mind, and turning to FIG. 1, a method 100 is depicted, in flowchart form, for processing data generated as part of an ongoing healthcare delivery operation, such as may be provided by a hospital or clinic. In the depicted example, a set of static data 102 is provided. The static data 102 may be, for example, patient demographic data or electronic medical records or other forms of static (i.e., non-time referenced) data. The static data 102 may be stored in one or more databases or files and may be generated (block 104) or derived from existing patient records and/or from records generated as part of the patient intake or treatment process.

In the depicted example, a set of dynamic data 106 is also provided. The dynamic data may be, for example, date/time-stamped data derived (block 108) during the patient intake, treatment, or discharge processes. In one embodiment, the dynamic data 106 may be location and/or time and date specific records indicating when a patient was checked into the hospital or a floor or unit of the hospital, what time the patient was placed in a bed or room, what time a treatment or treatments were administered, times that vital signs were checked or monitored, as well as discharge or transfer times. That is, in such an implementation, the dynamic data 106 may represent the spatial and/or temporal flow of the patient through the hospital and through the care delivery process.

In the depicted example, one or more dynamic models 110 are derived (block 112) based on the dynamic data 106. In this embodiment, the dynamic models 110 represent the care delivery process. The dynamic models 110 may take any suitable form, such as one or more flowcharts or process charts, workflow descriptions, treatment protocols, and so forth.

Likewise one or more static models 114 are derived (block 116) based on the static data 102. In one implementation, the static models 114 may describe key process indicators (KPI) and/or patient outcomes based on the available static data. For example, the static models 114 may be provided as suitable statistical or mathematical representations or derivations of the static data 102, such as regression analyses, cluster analysis, or analysis of variance or covariance (e.g., ANOVA, ANCOVA) that characterize a KPI or outcome event based on the static data 102 of the appropriate population of patients.

In this example, the static models 114 and dynamic models 110 are provided as inputs to an analysis process (block 116). The analysis process 116 in turn outputs one or more As-Is models 118 that model the actual observed process, as reflected in the dynamic data 106 and static data 102, and thus describe the expected values of care. That is, the As-Is models 118 reflect the process or processes under review as they are actually being implemented, as evidenced by the dynamic data 106 and static data 102 and the models 110, 114 derived based upon this data.

In the depicted example, the As-Is model 118 may be characterized or used to derive an updated dynamic model 122 and an updated static component model 124, one or both of which may be used to perform or revise existing strategic planning (block 126) used in the operation of the healthcare facility, such as by revising how different patient demographic groups are handled by the delivery process in question. For example, instances of strategic planning in response to the updated dynamic models 122 and/or the updated static models 124 may include instituting procedure changes to remove capacity constraints or organizational responses to updated models describing patient outcomes as a function of patient demographics.

In one embodiment, the updated dynamic model 122 derived from the As-Is model 118 may provide an accurate representation of the actual processed or flows of patients through the healthcare delivery process in question. As such, the updated dynamic model 122 may be useful in identifying process constraints, such as bottlenecks or other throughput issues that exist in the existing healthcare delivery process. Examples of updated dynamic models 122 include models describing expected patient wait time or time spent by a patient in the emergency room.

Likewise, the updated static model 124 derived from the As-Is model 118 may provide an accurate representation of the actual factors and variables (such as patient demographic variables) associated with particular KPIs or patient outcomes and of the respective contributions of these factors and variables to the respective KPI or outcome. As a result, the updated static model 124 may also be useful in adapting the strategic plan to achieve improved KPIs and/or patient outcomes, such as by taking the appropriate patient data into account when formulating a treatment plan or process for different patient demographic groups. Examples of updated static models 124 include models describing the percentage of patients with the correct diagnosis or the amount of patient improvement.

The analysis process 116 also outputs one or more variation models 120 that model the variation, or risk, for care (e.g., noise or other unexplained deviations) that is not reflected in the As-Is models 118, i.e., data that cannot be explained by the As-Is model 118. As with the As-Is model 118, the variation model 120 may also be used to derive both dynamic and static components. For example, in the depicted embodiment the variation model 120 gives rise to a dynamic variation model in the form of process conformance data 130 that reflects noise or variation attributable to deviations from the process specified by the updated dynamic model 122, i.e., noise attributable to the failure to follow the process specified by the updated dynamic model 122. Examples of process conformance data 130 may include the percentage of times patients are diverted from the correct care pathway.

In the depicted example, the variation model 120 also gives rise to a static variation model, depicted in FIG. 1 as patient variation 132, that reflects noise or unexplained variation attributable to patients or demographic groups of patients not responding as predicted by the updated static model 124. Variation may also include alternative choices of pathway, whereas the static model typically captures the mainstream of the pathway. For example, a demographic group may demonstrate a higher treatment failure rate or greater variation than expected based on the updated static model 124. Examples of such patient variation 132 may include patient dependent variation in care outcome and the percentage of times patient co-morbidities preclude a particular care pathway.

The output of the variation models 120 may be used to generate patient process and outcome metrics. For example, the dynamic variation model (depicted here as process conformance 130) may be used to derive or update dynamic quality metrics (block 136). Similarly, the static variation model (depicted here as patient variation 132) may be used to derive or update static quality metrics (block 138). The respective dynamic and static quality metrics may be used in quality reporting (block 140). For example, reports generated based on the dynamic and static quality metrics may be used by the healthcare facility or unit for either manual or automated control of care delivery. As depicted in certain embodiment, such feedback to the care delivery process may be reflected in future iterations of patient and process data (i.e., static data 102 and dynamic data 106), which may in turn be processed in accordance with the present algorithm to update or revise the respective models and/or metrics.

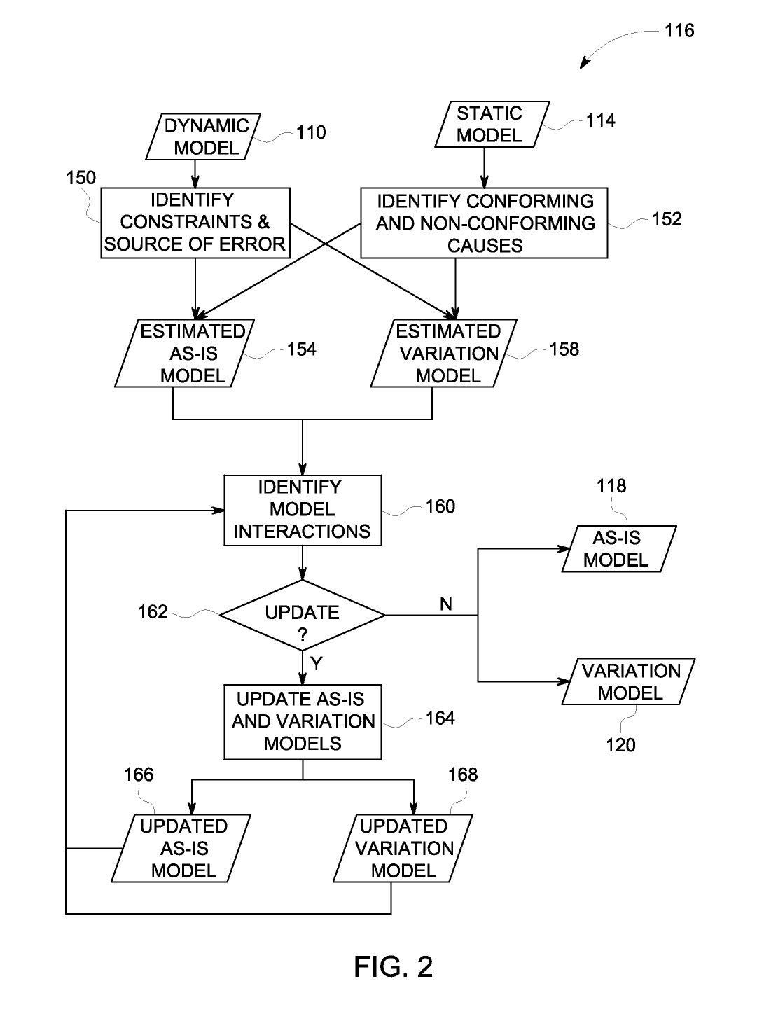

With the foregoing in mind and turning now to FIG. 2, an example of one implementation of the analysis function 116 is described. In this example, a dynamic model 110 is provided as an input. The dynamic model 110 may be a simulation model created using process mining techniques. For example, the dynamic model 110 may be created from a definition model of a delivery process verified against observed data (e.g., dynamic data 106). In one implementation, a series of simulation runs may be used (block 150) to create transfer functions that estimate the mean and variance of the care delivery based on process inputs. Such simulation runs may be used to identify constraints and/or sources of error in the healthcare delivery process.

In addition, a static model 114 is provided as an input to the analysis process 116. In one implementation, the static model 114 is created using data mining techniques that establish relationships (e.g., correlations) between variables associated with a healthcare delivery process are derived from the static data 102. For example, statistical techniques such as analysis of variance (ANOVA), analysis of covariance (ANCOVA), regression-based methods, and clustering-based methods may be employed (block 152) to identify patterns in process output estimates based upon the static data 102 provided. Examples, of such demographic or subgroup variables may include, but are not limited to: age, sex, per-existing or co-existing conditions, physical condition or parameters, physiological descriptors, and so forth. The total observed process mean and variance is the combination of the mean and variance accounted for by discovered groups (i.e., special or non-conforming causes) and the mean and variation accounted for by common (i.e., conforming) causes.

The results of the analyses (150, 152) of the dynamic model 110 and static model 114 may be used to derive a first iteration of the As-Is model and the variation model, i.e., estimated As-Is models 156 and estimated variation models 158. In the depicted example, once the estimated As-Is models 156 and estimated variation models 158 these models may be evaluated (block 160) for interactions between the dynamic and static components of these first iteration models. In one implementation, interactions are identified by re-estimating the transfer functions for the dynamic model 110 using the groups identified (i.e., special or non-conforming causes) in the analysis (block 152) of the static model 114. In this manner, it may be determined if interactions exist between the process and the different groups of patients receiving healthcare based on the process in question.

In the depicted example, a determination (block 162) is made based on the results of the interaction analysis 160 as to whether the estimated As-Is models 156 and estimated variation models 158 will be updated. In one such example, if no substantive interactions are identified, a determination may be made that no update is needed and the estimated As-Is models 156 and estimated variation models 158 may be finalized and output as the As-Is model 118 and the variation model 120. Conversely, if interactions are identified at block 160, a determination may be made to update (block 164) the estimated As-Is models 156 and estimated variation models 158 in view of the identified interactions between one or more subgroups of patients and the modeled process, thereby generating an updated As-Is model 166 and an updated variation model 168. In one implementation, the updated As-Is model 166 and the updated variation model 168 may be output as the As-Is model 118 and the variation model 120, i.e., there is only one update iteration. In other embodiments, including the embodiment depicted in FIG. 2, the updated As-Is model 166 and the updated variation model 168 may be iteratively analyzed for problem interactions until it is determined that no further updates are needed (e.g., when no additional substantive patient/process interactions are identified.

In one embodiment, some or all of the steps of the processes 100 and 116 discussed herein may be implemented as one or more algorithms stored as code on a non-transitory tangible machine-readable medium, such as a mass storage device (e.g., a magnetic or solid state hard drive, an optical disk, or a solid-state memory device) or a memory device (e.g., a solid-state memory board). The code, when executed by a processor, may perform some or all of the actions noted herein, such as the generation and/or analysis of the dynamic models, static models, As-Is models, and/or variation models. The processing circuitry may also interact with interface circuitry (i.e., an input/output interface) designed to support an operator interface by which a user may review the results of the executed code and/or may provide feedback or input as the code executes, such as to provide parameters or instructions as the code is executed.

In certain implementations the processing circuitry may include specially programmed hardware, memory, or processors (e.g., application-specific integrated circuits (ASICs)) for performing the operations discussed herein. Similarly, all or part of the model generation and/or analysis process may be performed using one or more general or special purpose processors and stored code or algorithms configured to execute on such processors. Likewise, a combination of special purpose hardware and/or circuitry may be used in conjunction with one or more processors configured to execute stored code to implement the steps discussed herein.

In an institutional setting, the analysis system may be coupled to one of more networks to allow for the acquisition and/or transfer of data (e.g., dynamic and static data) to and from the analysis system, as well as to permit transmission and storage of models and analysis results. For example, a local area networks, hospital information systems, wide area networks, wireless networks, and so forth may allow for storage of data and/or models on hospital information systems.

Technical effects of the invention include the combined analysis of static and dynamic models, such as to determine model interactions between subgroups of patients and a healthcare delivery processes. Other technical effects include the calculation of an As-Is model having dynamic and static components reflecting the actual flow of patients through a healthcare delivery process and the calculation of a variation model having dynamic and static components reflecting noise or other deviations from the As-Is model. Additional technical effects include using the As-Is model in strategic planning and using the dynamic and static aspects of the variation model to generate respective quality metrics used in a report and control process.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An iterative method for analyzing healthcare delivery data, comprising:
generating a dynamic model describing a healthcare delivery process and a static model describing a patient pool;
jointly analyzing both the dynamic model and the static model to determine one or more interactions between one or more subgroups of the patient pool and the healthcare delivery process; and
modifying or monitoring the healthcare delivery process based on the one or more interactions to address the one or more interactions determined to exist for the one or more subgroups.

2. The method of claim 1, wherein the dynamic model comprises a flowchart or workflow diagram describing the healthcare delivery process.

3. The method of claim 1, wherein the dynamic model is generated using a set of dynamic data comprising date/time-stamped data generated by patients undergoing the healthcare delivery process.

4. The method of claim 1, wherein the static model comprises a mathematical, statistical, or simulation model describing a relationship between a key process indicator or a patient outcome and a plurality of variables describing the patient pool.

5. The method of claim 1, wherein the static model is generated using a set of static data comprising patient demographic data or electronic medical records.

6. The method of claim 1, comprising:
generating an As-Is model and a variation model as outputs of the joint analysis of the dynamic model and the static model, wherein the healthcare delivery process is modified or monitored based on one or both of the As-Is model and the variation model.

7. The method of claim 6, wherein the As-Is model comprises an updated dynamic model and an updated static model which describe the healthcare delivery process as it is currently being implemented.

8. The method of claim 6, wherein the variation model describes noise and variation that is not encompassed by the As-Is model.

9. The method of claim 6, wherein the variation model comprises a dynamic component describing failures in process conformance and a static component describing patient variability.

10. The method of claim 6, comprising:
generating one or more quality metrics using the variation model, wherein monitoring the healthcare delivery process utilizes the one or more quality metrics.

11. A method for analyzing healthcare delivery data, comprising:
providing a dynamic model and a static model as an input;
analyzing the dynamic model to identify constraints or sources of error in a healthcare delivery process;
analyzing the static model to identify one or more patient subgroups that fail to conform to a statistical expectation;
deriving an estimated As-Is model and an estimated variation model based on the analysis of the dynamic model and the analysis of the static model;
evaluating the As-Is model and the variation model for interactions between the one or more patient subgroups and the healthcare delivery process; and
updating the As-Is model and the variation model if interactions are identified.

12. The method of claim 11, wherein the dynamic model comprises a simulation model generated using process mining of data/time-stamped process data.

13. The method of claim 11, wherein the static model comprises a statistical model generated using data mining of one or both of patient demographic data or electronic medical records.

14. The method of claim 11, wherein analyzing the dynamic model comprises using a series of simulation runs to create one or more transfer functions that estimate the mean and variance of the healthcare delivery process based on process inputs.

15. The method of claim 11, wherein the one or more patient subgroups are characterized based on one or more of age, sex, per-existing or co-existing conditions, physical condition or parameters, or physiological descriptors.

16. The method of claim 11, wherein evaluating the As-Is model and the variation model for interactions comprises re-estimating the transfer functions for the dynamic model using the one or more groups subgroups identified in the analysis of the static model.

17. One or more non-transitory computer-readable media, the computer-readable media comprising one or more routines which, when executed by a processor, perform acts comprising:
analyzing a dynamic model and a static model to generate an As-Is model and a variation model each having dynamic and static components; and
modifying or monitoring a healthcare delivery process based on the dynamic and static components of one or both of the As-Is model and the variation model.

18. The one or more non-transitory computer-readable media of claim 17, wherein the one or more routines, when executed by the processor, perform acts comprising generating the dynamic model using date/time-stamped data generated by patients undergoing the healthcare delivery process.

19. The one or more non-transitory computer-readable media of claim 17, wherein the one or more routines, when executed by the processor, perform acts comprising generating the static model one or both of patient demographic data or electronic medical records

20. The one or more non-transitory computer-readable media of claim 17, wherein the As-Is-model comprises an updated dynamic model and an updated static model which describe the healthcare delivery process as it is currently being implemented and wherein the variation model describes noise that is not encompassed by the As-Is model.
